(19) United States
(12) Patent Application Publication
(10) Pub. No.: US 2021/0019045 A1
(43) Pub. Date: Jan. 21, 2021

(54) ELECTRONIC DISPLAY DEVICE FOR A GLASS COCKPIT OF A VEHICLE, VEHICLE AND ASSOCIATED DISPLAY METHOD

(71) Applicant: THALES, Courbevoie (FR)

(72) Inventors: Maxime CAILLAUD, Mérignac (FR); Yannick LE ROUX, Mérignac (FR); Cécile ANDRE, Le Haillan (FR)

(21) Appl. No.: 16/926,071

(22) Filed: Jul. 10, 2020

(30) Foreign Application Priority Data
Jul. 17, 2019 (FR) 19 08064

(51) Int. Cl. G06F 3/0488; B64D 43/00; B60K 35/00; G06F 3/0482; G06F 3/0484; G06F 3/041

(52) U.S. Cl. CPC G06F 3/04886; B64D 43/00; B60K 35/00; G06F 3/0482; B60Y 2200/51; G06F 3/0414; B60K 2370/1438; B60K 2370/1523; B60K 2370/785; G06F 3/04847

(57) ABSTRACT

The invention relates to an electronic display device for a glass cockpit comprising a plurality of screens, the display device comprising, for each screen, an interactive display configuration tool, the device being configured, for each screen, to:
display the configuration tool in at least one predetermined zone, the configuration tool comprising a plurality of user entry symbols each associated with a display configuration corresponding to the combination of a display format, a window size relative to the size of said screen, and a location of said window within said screen,
modify the display configuration of said screen if a user entry symbol is selected that is different from the user entry symbol corresponding to the current display configuration.

The present invention relates to an electronic display device for a glass cockpit of a vehicle control system, said cockpit comprising a plurality of screens, at least two screens of the plurality of screens being able to simultaneously display separate video streams respectively associated with different display formats.

The invention also relates to a vehicle, such as an aircraft, comprising a glass cockpit and further comprising such a display device.

The invention also relates to a display method for a glass cockpit of a vehicle implemented by such a display device of the vehicle.

The invention also relates to a computer program product including software instructions which, when implemented by computer equipment, carry out such a display method.

A vehicle refers to any apparatus able to move between two different geographical positions. Such a vehicle for example corresponds to an aircraft.

An aircraft refers to any piloted vehicle capable of flying at least within the Earth's atmosphere, such as an airplane or a helicopter.

A format refers to a screen region dedicated to displaying a set of elements associated with a predetermined function of the control system. For example, the format dedicated to displaying primary flight parameters (PFD, Primary Flight Display) corresponds to a screen region containing all of the elements allowing the pilot to control and/or pilot his vehicle, namely the attitude, speed, altitude, etc.

The present invention relates to the field of a display for a glass cockpit, in particular in an aircraft cockpit, also called CDS (Cockpit Display System) or in any other vehicle comprising a cockpit area with reconfigurable display elements.

The new generations of cockpit solutions are equipped with glass cockpits, in which the conventional dedicated hardware equipment items, such as needle instruments, are “virtualized” (that is to say, replaced) by screens, in particular LCD screens, together forming a coherent viewing surface. In other words, the set of screens provides display and interaction coherence between screens, a pilot being able to point with the cursor of his control member on the various screens.

Such an equipment virtualization results in increasing the number of displayable formats, the screens making it possible to display essential information for the control of the vehicle, such as that relative to navigation, communications provided by the embedded systems obeying certain integrity and availability constraints such as avionics systems when the vehicle is an aircraft.

The screens also make it possible to provide information other than that which is essential for the control of the vehicle, such as navigation maps, virtualized control panels, external camera video streams, control manuals, etc.

The number of displayable formats generally greatly exceeds the total display surface proposed by the screens of the glass cockpit, such that the pilot must reconfigure the display of the cockpit based on his operational needs or the mission assigned to the vehicle.

Such a task is complex to perform mentally in an optimal manner, since the number of possible display combinations is multiplied by the number of formats, the number of screens, and the number of display configurations within a same screen, and creates insecurity in particular if the pilot inadvertently deletes information that is essential for the control of the vehicle.

The aim of the invention is to propose a user (that is to say, pilot) entry mechanism for configuring the display of a glass cockpit, allowing the user to directly define different processing conditions of the display while keeping an optimal useful information retrieval area.

To that end, the invention relates to an electronic display device for a glass cockpit of a vehicle control system, said cockpit comprising a plurality of screens, at least two screens of the plurality of screens being able to simultaneously display separate video streams respectively associated with different display formats, the display device comprising, for each screen of at least part of the plurality of screens, an interactive display configuration tool, the device being configured, for each screen of said at least part, to:

display the configuration tool in at least one predetermined zone of said screen, the configuration tool comprising a plurality of user entry symbols, each symbol being associated with a display configuration corresponding to the combination of a display format, a display window size of said display format relative to the size of said screen, and a location of said display window of the display format within said screen,

modify the display configuration of said screen if a user entry symbol is selected that is different from the user entry symbol corresponding to the current display configuration of said screen.

Thus, with the electronic display device according to the invention, the user entry mechanism makes it possible, through the selection of a single user entry symbol, to directly apply a display configuration corresponding to a triplet of simultaneous settings, namely a setting pertaining to the display format, a setting pertaining to the display window size of the display format relative to the size of the considered screen, and the setting of a location of the display window of the display format within the screen, able to retrieve, if applicable, a combination of formats.

The display device according to the invention is then particularly advantageous to configure or reconfigure, locally, the display of each screen of a glass cockpit, in particular in case of new mission of the vehicle or navigation phase (e.g., departure or takeoff for an aircraft, cruising, arrival or landing for an aircraft, etc.).

Indeed, the display device according to the present invention concretely helps the user perform a local reconfiguration of the display of a glass cockpit using a man-machine interaction process guided by the selection of user entry symbol(s) within the configuration tool locally associated with each screen, each entry symbol being explicitly representative, for any user, of the display configuration (that is to say, a triplet of simultaneous settings of the display of the considered screen) that is associated therewith.

There is therefore a reliable causal link between the assistance provided to any user and the display device, in particular the signaling done, by the display device, using configuration tools each associated with a screen of the glass cockpit and each comprising the user entry symbols proposed above.

According to other advantageous aspects of the invention, the electronic display device comprises one or more of the following features, considered alone or according to all technically possible combinations:

the display device is configured to display the interactive display configuration tool continuously and/or temporarily on the video stream(s) being displayed on said screen, and wherein:
the surface of said at least one predetermined zone is strictly smaller than half of the surface of each screen of the plurality of screens, and
the location of said at least one predetermined zone, on said screen, is different from the location of a zone dedicated to the display of information essential for the control of the vehicle, the location of said at least one predetermined zone depending on the current display configuration of said screen;

in order to display the configuration tool temporarily, the display device can be activated by:
mechanical pressure on a dedicated physical button of said screen; and/or
tactile pressure or pointing on a virtual button of said screen; and/or
a predetermined tactile gesture on the surface of said screen;

when the interactive display configuration tool is configured to be displayed temporarily, the device is configured to close the configuration tool automatically after activation of the user entry symbol, and/or after expiration of a predetermined time period, and/or after detection of a user entry outside of said at least one predetermined display zone of the configuration tool;

the display device is configured to make a user entry symbol selectable from said plurality of user entry symbols as a function of the current display configuration of said screen and/or as a function of the position of said screen within said cockpit and/or as a function of the current display configuration of at least one other screen of said plurality of screens, said at least one other screen being separate from said screen;

the configuration tool corresponds to a sequenced list of the set of display configurations of the formats displayable on at least one of the screens of said plurality of screens, each row of the sequenced list being associated with the display format of said set of displayable display formats and comprising as many user entry symbols as there are display configuration(s) associated with said display format of the row and displayable at least once on said screen;

when the interactive display configuration tool is configured to be displayed temporarily, the order of the set of display configurations of the displayable display formats of the sequenced list is invariable from one screen of the plurality of screens to the next;

the display device is configured to display each user entry symbol according to four distinct states corresponding to:

the current display configuration,

a display configuration displayable from the current display configuration,

a display configuration displayable at least once on said screen but not displayable from the current display configuration,

a display configuration never displayable on said screen.

The invention also relates to a vehicle, such as an aircraft, comprising a glass cockpit, the vehicle further comprising a display device as defined above.

The invention also relates to a display method for a glass cockpit of a vehicle implemented by a display device of the vehicle, the device being intended to provide video streams to a plurality of viewing screens of said cockpit, at least two screens of the plurality of screens being able to simultaneously display separate video streams respectively associated with separate display formats, the device comprising an interactive display configuration tool, for each screen of said at least one part, the method comprising at least:

displaying the configuration tool in at least one predetermined zone of said screen, the configuration tool comprising a plurality of user entry symbols, each symbol being associated with a display configuration corresponding to the combination of a display format, a display window size of said display format relative to the size of said screen, and a location of said display window of the display format within said screen,

modifying the display configuration of said screen if a user entry symbol is selected that is different from the user entry symbol corresponding to the current display configuration of said screen.

The invention also relates to a computer program including software instructions which, when executed by a computer, implement a display method as defined above.

These features and advantages of the invention will appear more clearly upon reading the following description, provided solely as a non-limiting example, and done in reference to the appended drawings, in which:

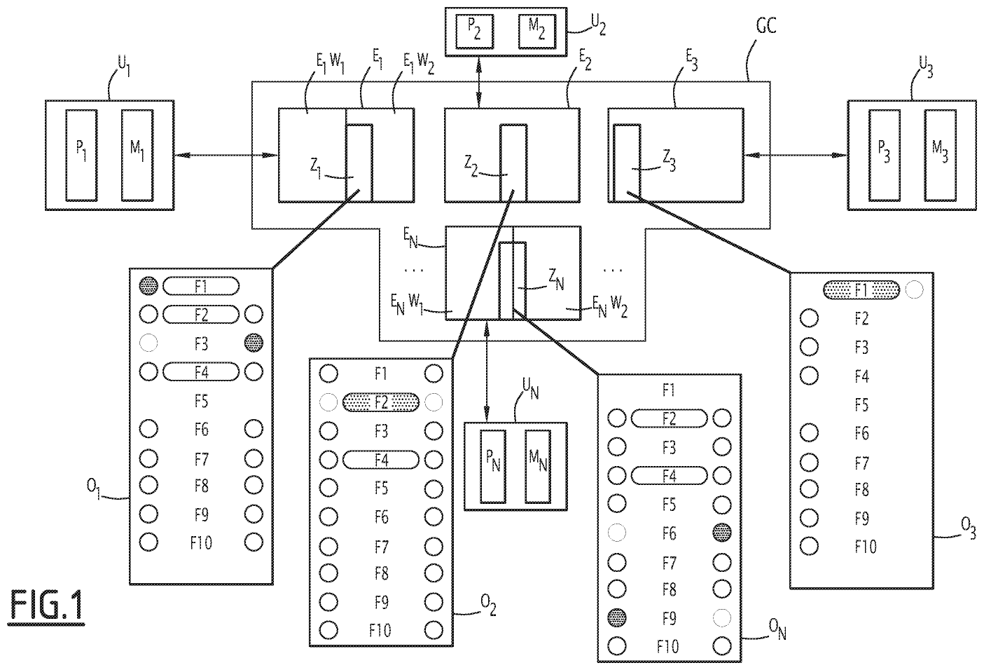

FIG. 1 is a schematic illustration of the display, for each screen of a glass cockpit, of an interactive configuration tool of a display device according to the invention;

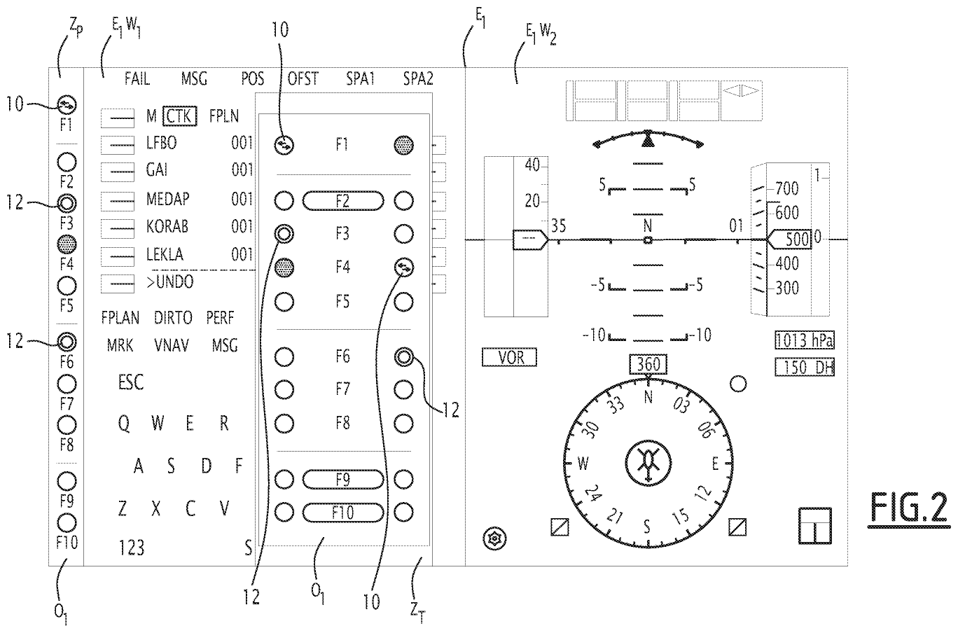

FIG. 2 is an example of configuration tools able to be displayed continuously and/or temporarily on a screen of the glass cockpit; and

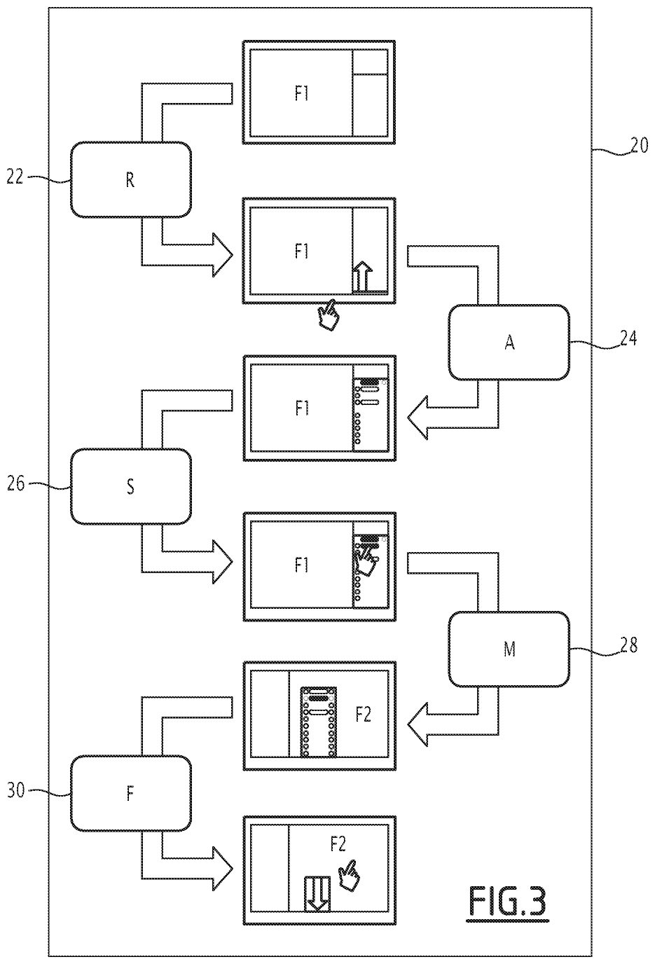

FIG. 3 is a flowchart of a display method according to the invention.

In the remainder of the description, the expression “substantially equal to” designates a relationship of equality to within plus or minus 10%, preferably to within plus or minus 5%.

In FIG. 1, a glass cockpit GC comprises a plurality of N screens, in particular touch-sensitive screens, N being an integer greater than or equal to one. According to the example of FIG. 1, four screens, namely the screens E₁, E₂, E₃ and E_{N} of the plurality of N screens, are shown.

According to the example of FIG. 1, each screen E is controlled by a processing unit U that is specific to it, a processing unit comprising at least a processor and a memory. In other words, associated with the screen E₁ is the processing unit U₁ comprising at least a processor P₁ and a memory M₁, associated with the screen E₂ is the processing unit U₂ comprising at least a processor P₂ and a memory M₂, associated with the screen E₃ is the processing unit U₃ comprising at least a processor P₃ and a memory M₃, . . . , associated with the screen E_{N} is the processing unit U_{N} comprising at least a processor P_{N} and a memory M_{N}.

The combination of the N processing units U₁, U₂, U₃, . . . , U_{N} forms the display device according to the present invention configured to locally adapt the display of a screen, independently from one screen to another.

According to one aspect that is not shown, only P screens among the N are associated with a processing unit allowing the reconfiguration of their own display, P being strictly less than N, the format of the N-P other screens of the glass cockpit not being reconfigurable and as a result being permanent, in particular for safety reasons.

According to the present invention, the display device comprises, respectively for each screen of (all or part of) the plurality of screens E₁, E₂, E₃, . . . , E_{N}, an interactive display configuration tool O₁, O₂, O₃, . . . , O_{N}.

According to one particular aspect, the display device is able to be activated, irrespective of the flight conditions, by manual action by the user, for example by: mechanical pressure on a dedicated and/or existing physical button (or cursor) of each screen of the plurality of screens of the glass cockpit; and/or by tactile pressure or pointing on a virtual button of each screen, and/or by a predetermined tactile gesture on the surface of each screen.

A predetermined tactile gesture for example refers to a double or triple tap by a finger, a continuous finger swipe, a separation of two fingers on the tactile surface of the screen, etc.

In the example of FIG. 1, the interactive display configuration tool O₁ is made in the form of software, or a software component executable by the processor P₁ of the processing unit U₁ associated with the screen E₁. The memory M₁ is then able to store such interactive display software O₁ to locally allow the configuration of the display of the screen E₁. The processor P₁ is then able to execute such interactive display software O₁.

Likewise, the interactive display configuration tool O₂ is made in the form of software, or a software component executable by the processor P₂ of the processing unit U₂ associated with the screen E₂. The memory M₂ is then able to store such interactive display software O₂ to locally allow the configuration of the display of the screen E₂. The processor P₂ is then able to execute such interactive display software O₂.

The interactive display configuration tool O₃ is also made in the form of software, or a software component executable by the processor P₃ of the processing unit U₃ associated with the screen E₃. The memory M₃ is then able to store such interactive display software O₃ to locally allow the configuration of the display of the screen E₃. The processor P₃ is then able to execute such interactive display software O₃.

And so forth until the interactive display configuration tool O_{N} is also made in the form of software, or a software component executable by the processor P_{N} of the processing unit U_{N} associated with the screen E_{N}. The memory M_{N} is then able to store such interactive display software O_{N} to locally allow the configuration of the display of the screen E_{N} The processor P_{N} is then able to execute such interactive display software O_{N}.

In a variant, the interactive display configuration tools O₁, O₂, O₃, . . . , O_{N} are each made in the form of a programmable logic component, such as an FPGA (Field Programmable Gate Array), or in the form of a dedicated integrated circuit, such as an ASIC (Application Specific Integrated Circuit).

When part of the display device is made in the form of one or several software programs, i.e., in the form of a computer program, this part is further able to be stored on a medium, not shown, readable by computer. The computer-readable medium is for example a medium suitable for storing electronic instructions and able to be coupled with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

According to the example of FIG. 1, the display device according to the present invention is configured, for each screen, to:
display the configuration tool O in at least one predetermined zone Z of the considered screen E, the configuration tool comprising a plurality of user entry symbols, each symbol being associated with a display configuration corresponding to the combination of a display format, a display window size of the display format relative to the size of the considered screen E, and a location of the display window of the display format within the considered screen E,
modify the display configuration of the considered screen E if a user entry symbol is selected that is different from the user entry symbol corresponding to the current display configuration of the considered screen E.

In the example of FIG. 1, the display device, via the unit U₁, is able to display the configuration tool O₁ in the predetermined zone Z₁ of the window E₁W₂ in line with the screen E₁.

According to one particular aspect, the configuration tool O₁ corresponds to a sequenced list of the set of display configurations of the formats F1, F2, F3 . . . F10 displayable on at least one of the screens of the plurality of screens E₁, E₂, E₃, . . . , E_{N}.

As a non-limiting example, the first format F1 corresponds to the format dedicated to the display of primary flight parameters (PFD, Primary Flight Display), the format F2 is the format dedicated to the display of navigation parameters (ND, Navigation Display), such as the heading, the format F3 is dedicated to the display of parameters associated with the mission of the vehicle, such as the search and rescue mission, an oil and gas mission, etc., the format F4 is dedicated to the display of virtualized control panels for example allowing a three-dimensional representation of the relief, an aeronautic diagram or a depiction of an airport, the format F5 is dedicated to the flight management system (FMS), the format F6 is dedicated to the configuration of communication means, for example high frequency HF and very high frequency VHF, the format F7 is dedicated to the monitoring of the states of elements of the piloting system, the format F8 is dedicated to the display of piloting procedures, the format F9 is dedicated to the display of external camera video streams, the format F10 is dedicated to the display of map(s), etc.

Any other format wording combination F1, F2, F3 . . . F10 in the aforementioned examples of formats can be considered, for example the wording format F7 is dedicated to the display of map(s), while the wording format F10 is dedicated to monitoring the states of elements of the piloting system.

More specifically according to this particular aspect, each row of the sequenced list is associated with a display format of the set of displayable display formats and comprises as many user entry symbols as there are associated display configuration(s) associated with the display format of the row and displayable at least once on the considered screen.

In particular, the display device is configured to display each user entry symbol according to four different states corresponding to the current display configuration, a display configuration displayable from the current display configuration, a display configuration displayable at least once on said screen but not displayable from the current display configuration, a display configuration never displayable on said screen.

These four states are predetermined, known by the user and explicit (that is to say, each obviously associated for any user with a display configuration that is specific to it).

According to the example of FIG. 1, a user entry symbol is identifiable by a user by the presence of a contour that here is round or oval, the thickness of the contour having two distinct values, the higher one indicating that the symbol is selectable by the user and the lower one indicating that the symbol is not selectable from the display configuration in the process of being retrieved.

The absence of user entry symbol (that is to say, contour) indicates to the user that the associated display configuration is never displayable on the considered screen.

The filling of the contour of a user entry symbol by a texture, dots according to the example of FIG. 1, or a predetermined color, for example a white fill when the background of the configuration tool is black, indicates that the display configuration associated with such a user entry symbol is the current display configuration.

Thus, in particular considering the configuration tool O₁ associated with the screen E₁, the current display configuration is therefore shown by a user entry symbol in dotted lines and in particular corresponds to the display of the format F1 in the window E₁W₁ on the left of the screen E₁ and the display of the format F3 in the window E₁W₂ of this same screen E₁. The size of each of the windows E₁W₁ and E₁W₂ is equal to the size of the half-screen E₁.

The format F1 can also be displayed in full-screen, the symbol central to the oval contour of the line F1 being selectable. Conversely, in the screen E₁, the symbol allowing the selection of the display configuration corresponding to the combination of the format F1, the window size corresponding to a half-screen, and the location on the right of this window is missing from the configuration tool O₁, making it impossible to perform such a selection of a display configuration corresponding to a triplet of simultaneous settings, namely a setting relative to the display format, a setting relative to the display window size of the display format relative to the size of the considered screen, and the setting of a location of the display window of the display format within the screen.

Regarding the format F2, like the format F4, three user entry symbols are selectable in order to modify the current display configuration, namely a display of the format F2 in the window E₁W₁ on the left side of the screen E₁, a display of the format F2 in full screen, and a display of the format F2 in the window E₁W₂ on the right side of the screen E₁.

As previously indicated, the display of the format F3 in the right window E₁W₂ of this same screen E₁ corresponds to the current display configuration, the format F3 is never displayable in full screen according to the example of FIG. 1 and the display of the format F3 in the left window E₁W₁ on the screen E₁ is possible but not displayable from the current display configuration, the round user symbol associated with the display of the format F3 in the left window E₁W₁ having a finer contour than the other selectable user symbols.

No display configuration of the format F5 is displayable (that is to say, accessible) on the screen E₁, since no user entry symbol shown in FIG. 1 by a round or oval contour is present on the row of the configuration tool O₁.

Regarding the formats F6 to F10, two user entry symbols are selectable in order to modify the current display configuration, namely a display of one of these formats in the window E₁W₁ on the left side of the screen E₁ and a display of the format F2 in the window E₁W₂ on the right side of the screen E₁.

Similarly, the display device, via the unit U₂, is able to display the configuration tool O₂ in the predetermined zone Z₂ of the screen E₂.

For the screen E₂, the current display configuration is, according to the example of FIG. 1, shown by a user entry symbol in dotted lines and in particular corresponds to the display of the format F2 in full screen. The display of the format F2 in a left window (not shown) or a right window (not shown) of the screen E₂ is possible but not displayable from the current display configuration, the round user symbols associated with the display of the format F2 in a left window or a right window of the screen E₂ having a finer contour than the other selectable user symbols.

Regarding the formats F1, F3 and F5 to F10, two user entry symbols are selectable in order to modify the current display configuration, namely a display of one of these formats in a window on the left side of the screen E₂ and a display of the [sic] of one of these formats in a window on the right side of the screen E₂.

Regarding the format F4, three user entry symbols are selectable in order to modify the current display configuration, namely a display of the format F4 in a window on the left side of the screen E₂, a display of the format F4 in full screen, and a display of the format F4 in a window on the right side of the screen E₂.

Similarly, the display device, via the unit U₃, is able to display the configuration tool O₃ in a predetermined zone Z₃ of the screen E₃.

For the screen E₃, the current display configuration is, according to the example of FIG. 1, shown by a user entry symbol in dotted lines and in particular corresponds to the display of the format F1 in full screen.

On the screen E₃, in full screen, only the display of the format F1 is possible. To modify the current display configuration, the user can only select one of the user entry symbols associated with one of the formats F2 to F4 or one of the formats F6 to F10 associated with a display configuration of this format in a window located on the left side and of smaller size than the size of the screen E₃.

No display configuration of the format F5 is displayable (that is to say, accessible) on the screen E₃, since no user entry symbol shown in FIG. 1 by a round or oval contour is present on the row of the configuration tool O₃.

The display configuration of the format F1 in a right window of predetermined size on the screen E₃ is possible, but not displayable from the current display configuration, the round user symbol associated with the display of the format F1 in a right window having a finer contour than the other selectable user symbols. In other words, the display configuration of the format F1 in a right window of predetermined size on the screen E₃ cannot directly follow from the current display configuration.

It should be noted that in the right window of the screen E₃ in light of the selectable user entry symbols of the configuration tool O₃, only the format F1 is retrievable in the right window of this screen E₃ either via a full-screen configuration or via a configuration with a window equal in size to a half-screen located on the right side.

Similarly, the display device, via the unit U_{N}, is able to display the configuration tool O_{N} in a predetermined zone ZN of the screen E_{N}

For the screen E_{N}, the current display configuration in particular corresponds to the display of the format F9 in the window E_{N}W₁ on the left side of the screen E_{N} and the display of the format F6 in the window E_{N}W₂ of this same screen E_{N}. The size of each of the windows E_{N}W₁ and E_{N}W₂ is equal to the size of the half-screen E_{N}.

No display configuration of the format F1 is displayable (that is to say, accessible) on the screen E_{N}, since no user entry symbol shown in FIG. 1 by a round or oval contour is present on the row of the configuration tool O_{N}.

Regarding the format F2, like the format F4, three user entry symbols are selectable in order to modify the current display configuration, namely a display of the format F2 in the window E_{N}W₁ on the left side of the screen E_{N}, a display of the format F2 in full screen, and a display of the format F2 in the window E_{N}W₂ on the right side of the screen E₁.

Regarding the formats F3, F5, F7, F8 and F10, two user entry symbols are selectable in order to modify the current display configuration, namely a display of one of these formats in a window on the left side of the screen E_{N} and a display of one of these formats in a window on the right side of the screen E_{N}.

As previously indicated, the display of the format F6 in the right window E_{N}W₂ of this same screen E_{N} corresponds to the current display configuration, the format F6 is never displayable in full screen according to the example of FIG. 1 and the display of the format F6 in the left window E_{N}W₁ on the screen E₁ is possible but not displayable from the current display configuration, the round user symbol associated with the display of the format F6 in the left window E_{N}W₁ having a finer contour than the other selectable user symbols.

Likewise, the display of the format F9 in the left window E_{N}W₁ of this same screen E_{N} corresponds to the current display configuration, the format F9 is never displayable in full screen according to the example of FIG. 1 and the display of the format F9 in the right window E_{N}W₂ on the screen E₁ is possible but not displayable from the current display configuration, the round user symbol associated with the display of the format F9 in the left window E_{N}W₁ having a finer contour than the other selectable user symbols.

According to one particular aspect, normative or technical constraints may impose or prevent certain display configurations, the display device according to the invention is configured to make automatically (that is to say, without human intervention) selectable (and conversely, non-selectable), a user entry symbol from the plurality of user entry symbols of the configuration tool as a function of the current display configuration of the considered screen and/or as a function of the position of the screen within the cockpit GC and/or as a function of the current display configuration of at least one other screen of the plurality of screens.

In other words, in relation with FIG. 1, a coherence between the various local configuration tools O₁, O₂, O₃, . . . O_{N} each respectively associated with a separate screen is optionally implemented by the display device according to the present invention. To that end, the processing units U₁, U₂, U₃, . . . U_{N} of the display device according to the present invention are for example interconnected by wireless or wired links, not shown, so as to communicate their respective current display configurations to one another so that the display device, by means of an additional dedicated processor or by means of one of the processors P₁, P₂, P₃, . . . , P_{N} of the processing units, determines, practically in real time, or in real time, if there is for example still at least one screen, from the plurality of screens of the glass cockpit GC, whose display configuration corresponds to the primary flight display PFD format F1.

According to the example of FIG. 1, the interactive configuration tools O₁, O₂, O₃, . . . O_{N} are configured to be displayed temporarily and independently of one another on the video stream in the process of being retrieved on each screen with which each configuration tool is associated.

In particular, when the interactive display configuration tool is configured to be displayed temporarily, the order of the set of display configurations of the displayable display formats of the sequenced list is invariable from one screen of the plurality of screens to the next. In other words, each interactive configuration tool O₁, O₂, O₃, . . . O_{N} comprises a first line associated with the same format F1 from one configuration tool to the next, a second line associated with the same format F2 from one configuration tool to the next, a third line associated with the same format F3 from one configuration tool to the next, etc.

Such a display invariability within an interactive configuration tool from one screen to another facilitates and accelerates the search for the desired display format by the user when he seeks to change the current display configuration, and reduces the risk of entry error of his choice.

In relation with FIG. 2, the display device is configured to display the interactive display configuration tool continuously and/or temporarily on the video stream(s) being displayed on a considered screen.

In other words, on one or several screens E₁, E₂, E₃, . . . , E_{N} of the plurality of screens of the cockpit GC of FIG. 1, an interactive display configuration tool according to the invention displayable temporarily in a predetermined zone Z_{T} is able to be completed or replaced by an interactive display configuration tool displayable continuously in at least one predetermined zone Z_{P}.

According to the example of FIG. 2, an interactive display configuration tool O₁ associated with the screen E₁ is displayed completely (that is to say, exhaustively) in the predetermined temporary display zone Z_{T} and in addition is displayed in a reduced manner (that is to say, in a shortened or limited manner relative to the temporary display in the predetermined zone Z_{T}) continuously in the predetermined zone Z_{P}.

According to one particular aspect of the invention, the surface of the predetermined temporary display zone, like that of the predetermined permanent display zone Z_{P}, is strictly smaller than half of the surface of the screen E₁. According to the present invention, the same is true for any configuration tool, in other words, the surface of the predetermined display zone of a configuration tool is always strictly less than half of the surface of each screen of the plurality of screens of the glass cockpit.

Additionally, the location of the predetermined temporary display zone Z_{T} like that of the predetermined permanent display zone Z_{P}, on the screen E₁, is separate from the location of a zone dedicated to the display of the information essential for the piloting of the vehicle, the location of the predetermined temporary display zone Z₁, like that of the predetermined permanent display zone Z_{P}, depending on the current display configuration of the screen E₁.

In other words, the location and the size of the predetermined temporary display zone Z_{T} (that is to say, appearance/disappearance for a temporary display) is optimized so as to limit the masking of the formats, in particular avionic in the process of retrieval.

According to one variant that is not shown, the configuration tool O₁ is displayed by superposition, thus making it possible to see the retrieved video stream below.

In FIG. 2, the configuration tool O₁, when it is displayed temporarily, is contained in the optimized surface of the temporary display zone Z_{T} and is displayed above the avionic formats being retrieved. According to the example of FIG. 2, the current display configuration, according to the user entry symbols having a dotted texture, corresponds to format F1 retrieved in the right window E₁W₂ of the screen E₁ and format F4 retrieved in the left window E₁W₁ of the screen E₁.

The position (that is to say, location within the screen E₁) of the temporary display zone Z_{T} is adapted such that it does not hide the primary control parameters. Thus, in FIG. 2, the temporary display zone Z_{T} is located within the left window E₁W₁ of the screen E₁ while the primary control parameters associated with format F1 are retrieved and still visible in the right window E₁W₂ of the screen E₁.

Thus, even if the configuration tool O₁ is displayed temporarily in the temporary display zone Z_{T} (that is to say, several seconds), it is possible for the pilot of the aircraft to continue to monitor the parameters essential to his task, namely piloting, continuously.

Likewise, according to the configuration tool O₁ of FIG. 1 where the current display configuration, detectable by the dotted texture of the user entry symbols, corresponds to the display of format F1 in the left window E₁W₁, the temporary display zone Z_{T} this time is located within the right window E₁W₂ of the screen E₁ so as not to hide the primary control parameters associated with format F1 that have been retrieved and as a result are still visible in the left window E₁W₁ of the screen E₁.

Furthermore, compared to the configuration tool O₁ of FIG. 1 where the display of format F1 in the right window E₁W₂ of the screen E₁ was impossible, the configuration tool O₁ of FIG. 2 comprises a user entry symbol 10 comprising a first additional signal element, namely two arrows in opposite directions from one another, making it possible to display, after selection by the user, in place of the current display configuration corresponding to format F1 within the right window E₁W₂ of the screen E₁ and format F4 within the left window E₁W₁, format F1 within the left window E₁W₁ of the screen E₁ and format F4 within the right window E₁W₂ of the screen E₁.

Furthermore, the configuration tool O₁ of FIG. 2 comprises a user entry symbol 12 comprising a second additional signal element, namely, for example, two concentric contours (here round, but also able to be oval) making it possible to display, after selection by the user, directly, the display configuration preceding the current display configuration, the preceding display configuration corresponding to the display of format F3 within the left window E₁W₁ of the screen E₁ and the display of format F6 within the right window E₁W₂ of the screen E₁.

As an alternative to the entry symbol 12 comprising a second additional signal element, a dedicated entry symbol with an explicit mention such as “BACK” can be added within a configuration tool according to the present invention.

As illustrated by FIG. 2, the temporary display that can be implemented by the display device according to the present invention can be completed by a permanent display in the predetermined permanent display zone Z_{P}.

Such a predetermined permanent display zone Z_{P} for example comprises a banner, the width of which makes it possible to display a single user entry symbol per format, which is why reference is made to shortened or reduced permanent display relative to the complete temporary display, in particular with three user entry symbols per format, of the same configuration tool O₁.

Such a shortened permanent display makes it possible to reduce the graphic footprint (that is to say, the size) of the permanent display of the display configuration tool in order to optimize the size of the remaining surface of the considered screen dedicated to the display of the avionic format(s) to be retrieved on this screen, while offering the user the possibility of continuously viewing, with immediate access, the format(s) in the process of being retrieved, namely, in FIG. 2, formats F4 and F1, the retrieval window of which is interchangeable, as indicated by the user entry symbol 10, and the preceding display configuration, namely formats F3 and F6, as indicated by the user entry symbol 12.

Such a banner is for example located adjacent to one or several of the sides of the screen and inside the considered screen.

According to the example of FIG. 2, the order of all of the display configurations of the displayable display formats of the configuration tool O₁ displayed in the permanent banner is identical to that of the configuration tool O₁ displayed temporarily.

According to another example, not shown, the permanent banner is able to retrieve only a predetermined subset of the display configurations available in the configuration tool O₁ displayed temporarily superimposed on the screen, such a permanent banner subset being able to differ from one screen to another, like the order of the display configurations of such a permanent banner subassembly. From such a permanent banner, the temporary display of the configuration tool O₁ in the temporary display zone Z_{T} is for example activated by tactile pressure in the banner, that is to say, the predetermined permanent display zone Z_{P}.

According to another example, not shown, a dual display of permanent banners (that is to say, on both the left and right sides of the considered screen) is implemented.

According to one particular aspect, when the interactive display configuration tool is configured to be temporarily displayed, the display device is configured to close automatically, the configuration tool O₁ displayed in the temporary display zone Z₁, after activation of a user entry symbol (the activation being equivalent to selection of a new display configuration to be applied), and/or after expiration of a predetermined time period, and/or after detection of a user entry outside the predetermined display zone Z_{T} of the configuration tool (for example in case of user entry on a screen other than the screen E₁ or by new mechanical pressure on the dedicated button of the screen that activated the display of the configuration tool).

One non-limiting example of operation of the display device according to the invention will now be explained using FIG. 3, showing an exemplary flowchart of a display method 20 according to the invention.

During a first step 22 of such a display method 20, the display device is for example activated by receiving R a manual mechanical pressure on a dedicated button of one of the screens of the glass cockpit. According to other examples, such an activation of the display device is done via the tactile pressure or the pointing of a virtual button of the considered screen or the entry of a predetermined tactile gesture on the surface of said screen.

During a following step 24, the display device performs the display A of the configuration tool locally on this screen.

During a following step 26, the display device receives the entry S of the display configuration selected by the user by pressing of the desired user entry symbol.

During a following step 28, the display device implements the modification M of the current display configuration according to the display configuration previously selected by the user, and in case of selection of a user entry symbol different from the user entry symbol corresponding to the current display configuration. In other words, the retrieved format is different before and after step 28.

During a final step 30, the display device closes F the configuration tool. Such closing is done either automatically before expiration of a predetermined time period, or manually by pressure outside the configuration tool, or by pressure on the mechanical or virtual button used to open the configuration tool.

One can thus see that the display device according to the present invention allows the pilot to adapt, effectively, intuitively and while limiting the risk of errors, the display configuration of his cockpit as a function of the task/mission that he must perform.

Such effectiveness is in particular obtained via a configuration tool associated with each screen of the glass cockpit of the cockpit and locally displayable on the screen that is specific thereto, each configuration tool comprising a set of explicit user entry symbols so that the pilot uses them to select the desired display configuration.

Furthermore, the display device according to the present invention is able to provide display coherence of configuration tools on the set of screens, and to optimize the size and the position of each configuration tool in order to locally limit, on each screen, the masking of avionic formats during retrieval, which allows the pilot to keep his attention on the essential parameters of the formats displayed for the time needed for the display reconfiguration task.

Furthermore, according to one particular aspect, in order to facilitate the use by the pilot and the effectiveness of the reconfiguration task, the order of the display formats of the configuration tool displayed temporarily is the same over all of the screens of the cockpit. Nevertheless, normative or technical constraints can impose or prevent certain display configurations. In order for the pilot not to be required to know these constraints in order to understand the behavior of the system (which would result in complicating his task, therefore potentially increasing his workload, or even in some situations downgrading the safety of the operation if he must act urgently), the configuration tool explicitly shows the current display configuration on the screen associated with the configuration tool, the display configuration(s) that are displayable from the current display configuration, the display configuration(s) that are displayable at least once on the screen but are not displayable from the current display configuration, the display configuration(s) that are never displayable on the considered screen.

1. An electronic display device for a glass cockpit of a vehicle control system, said glass cockpit comprising a plurality of screens, at least two screens of the plurality of screens being able to simultaneously display separate video streams respectively associated with different display formats,
wherein the display device comprises, for each screen of at least part of the plurality of screens, an interactive display configuration tool, the device being configured, for each screen of said at least one part, to:
display the configuration tool in at least one predetermined zone of said screen, the configuration tool comprising a plurality of user entry symbols, each symbol being associated with a display configuration corresponding to the combination of a display format, a display window size of said display format relative to the size of said screen, and a location of said display window of the display format within said screen,
modify the display configuration of said screen if a user entry symbol is selected that is different from the user entry symbol corresponding to the current display configuration of said screen.

2. The display device according to claim 1, wherein the display device is configured to display the interactive display configuration tool continuously and/or temporarily on the video stream(s) being displayed on said screen, and wherein:
the surface of said at least one predetermined zone is strictly smaller than half of the surface of each screen of the plurality of screens, and
the location of said at least one predetermined zone, on said screen, is different from the location of a zone dedicated to the display of information essential for the control of the vehicle, the location of said at least one predetermined zone depending on the current display configuration of said screen.

3. The display device according to claim 1, wherein, in order to display the configuration tool temporarily, the display device can be activated by:
mechanical pressure on a dedicated physical button of said screen; and/or
tactile pressure or pointing on a virtual button of said screen; and/or
a predetermined tactile gesture on the surface of said screen.

4. The display device according to claim 2, wherein, when the interactive display configuration tool is configured to be displayed temporarily, the device is configured to close the configuration tool automatically after activation of the user entry symbol, and/or after expiration of a predetermined time period, and/or after detection of a user entry outside of said at least one predetermined display zone of the configuration tool.

5. The display device according to claim 1, wherein the display device is configured to make a user entry symbol selectable from said plurality of user entry symbols as a function of the current display configuration of said screen and/or as a function of the position of said screen within said cockpit and/or as a function of the current display configuration of at least one other screen of said plurality of screens, said at least one other screen being separate from said screen.

6. The display device according to claim 1, wherein the configuration tool corresponds to a sequenced list of the set of display configurations of the formats displayable on at least one of the screens of said plurality of screens, each row of the sequenced list being associated with the display format of said set of displayable display formats and comprising as many user entry symbols as there are display configuration(s) associated with said display format of the row and displayable at least once on said screen.

7. The display device according to claim 6, wherein, when the interactive display configuration tool is configured to be displayed temporarily, the order of the set of display configurations of the displayable display formats of the sequenced list is invariable from one screen of the plurality of screens to the next.

8. The display device according to claim 1, wherein the display device is configured to display each user entry symbol according to four distinct states corresponding to:
the current display configuration,
a display configuration displayable from the current display configuration,
a display configuration displayable at least once on said screen but not displayable from the current display configuration,
a display configuration never displayable on said screen.

9. A vehicle, such as an aircraft, comprising a glass cockpit wherein it further comprises a display device according to claim 1.

10. A display method for a glass cockpit of a vehicle control system, said method being implemented by a display device of the vehicle, said cockpit comprising a plurality of screens, at least two screens of the plurality of screens being able to simultaneously display separate video streams respectively associated with different display formats, the device comprising, for each screen of at least part of the plurality of screens, an interactive display configuration tool,
wherein for each screen of said at least one part, the method comprises at least:
displaying the configuration tool in at least one predetermined zone of said screen, the configuration tool comprising a plurality of user entry symbols, each symbol being associated with a display configuration corresponding to the combination of a display format, a display window size of said display format relative to the size of said screen, and a location of said display window of the display format within said screen,
modifying the display configuration of said screen if a user entry symbol is selected that is different from the user entry symbol corresponding to the current display configuration of said screen.

11. A computer program product comprising software instructions which, when executed by a computer, carry out a display method according to claim 10.
